(19) United States
(12) Patent Application Publication
(10) Pub. No.: US 2012/0007518 A1
(43) Pub. Date: Jan. 12, 2012

(54) HALOGEN LAMP FOR PULSE OPERATION

(75) Inventors: Barbara R. Muelders, Aachen (DE); Bernd Schoenfelder, Aachen (DE); Birgit Koeber, Eschweiler (DE)

(73) Assignee: KONINKLIJKE PHILIPS ELECTRONICS N.V., EINDHOVEN (NL)

(21) Appl. No.: 13/255,248

(22) PCT Filed: Mar. 3, 2010
(86) PCT No.: PCT/IB10/50916

§ 371 Date: Sep. 8, 2011

(30) Foreign Application Priority Data
Mar. 10, 2009 (EP) 09154711.7

(51) Int. Cl. H05B 41/30; H01J 17/20

(52) U.S. Cl. 315/246; 313/643

(57) ABSTRACT

The invention relates to a halogen automotive lamp for pulse width operation, a lighting assembly including a halogen lamp and to a method of operating a halogen lamp. The lamp comprises a transparent lamp vessel with a gas filling comprising a rare gas component and a halogen component. A filament is arranged within the vessel. In conventional halogen lamps operation with pulsed electrical power, such as e.g. PWM operation of automotive halogen lamps for cornering and bending light lead to shortened lifetimes. In order to propose a lamp with increased lifetime under pulse operation, the gas filling comprises nitrogen in an amount of 0.1-5 mol-%. It has surprisingly been found that filament deformation may be counteracted by the corresponding small amount of nitrogen.

### FIELD OF THE INVENTION

The present invention generally relates to a halogen lamp and a lighting assembly including such a lamp as well as a method of operating it. More specifically, the lamp is a halogen incandescent lamp that may be operated with pulsed electrical power.

### BACKGROUND OF THE INVENTION

As known to the skilled person, in a halogen lamp, the gas filling of a transparent lamp vessel which includes the filament comprises a rare gas component and a halogen component. In operation, a halogen cycle, in which (tungsten) material evaporating from the filament reacts with the halogen component, enables stable operation at high filament temperature.

Different types of halogen automotive lamps are available today, such as e. g. known H4, H7 or H8 type lamps. Automotive halogen lamps are adapted for installation and operation onboard of a motor vehicle by their electrical properties (adapted to be operated at the onboard voltage of 12 V at their nominal power), by their optical properties (i.e. fulfilling the standard requirements, e.g. for luminous flux) and by their geometrical/mechanical properties (i.e. filament in defined position, fitting in standardized reflector mounting parts).

WO2006/097058 discloses an incandescent halogen lamp, which in the shown example is an automotive H8 lamp to be operated at nominal voltage of 12 V aboard a motor vehicle. A tungsten filament is arranged within a lamp vessel made of quartz glass. The gas filling of the lamp vessel comprises a halogen component and a rare gas component. In a first embodiment, the rare gas component comprises krypton and argon at a cold filling pressure of 1.2 MPa. The halogen component comprises bromine, iodine and chlorine at a proportion of 450 ppm. In further embodiments with the same cold filling pressure and the same halogen component, the rare gas component comprises alternatively krypton and neon or krypton, neon and argon. It is stated that the resulting halogen incandescent lamps is well suited to be used in static curve light or turning light which is used within an automotive head lamp only in short intervals during turning or parking of the motor vehicle or when driving along a curved route. The halogen lamp may also be used as daylight running light at 12 V and as position light with half the onboard voltage at 6 V.

In novel AFS (advanced front lighting system) front lighting for motor vehicles, the static bending light and the cornering light functionality may be fulfilled by a halogen incandescent lamp, which will typically be arranged to cooperate with a separate reflector. Static bending light, which is used at steering angles above 10°, and cornering light, which is turned on together with the direction indicator, are operated automatically without a separate switch to be operated by the driver. In operation of the incandescent lamp for bending light and cornering light, the lamp, before being turned off, is driven with pulsed electrical power. In this type of operation, the lamp is consecutively switched on and off, where the voltage during the “on”-phase is substantially constant. Thus, the emitted light intensity is controlled by the corresponding driving scheme. In the case of a PWM (pulse width modulation) operation, the intensity is controlled by the duty cycle. PWM control is used when bending/cornering light is turned off Here, the intensity is gradually reduced rather than instantly switching off, in order not to irritate the driver.

It has been found that halogen incandescent lamps subjected to PWM operation have a significantly reduced lifetime. An analysis of failed lamps has revealed that operation with pulsed electrical power leads to increased filament deformation.

### SUMMARY OF THE INVENTION

It is an object of the present invention to provide an automotive halogen incandescent lamp suited for pulse operation. It is further an object to provide a lighting assembly including a halogen lamp and a method of operating it which achieves a long operational life of the lamp.

This object is achieved by a lamp according to claim 1, a lighting assembly according to claim 11 and a method according to claim 15. Dependent claims refer to preferred embodiments of the invention.

The present inventor has thoroughly analyzed filament deformation occurring in automotive halogen lamps driven with pulsed electrical power. As will be explained in detail below, thermal stress in the filament material causes mechanical failure. However, it has surprisingly been found that the underlying mechanism may be slowed down or even eliminated by addition of nitrogen to the gas filling of the lamp vessel.

According to the invention, the gas filling within the lamp vessel comprises, besides the rare gas component, halogen component and possible other additives, nitrogen in an amount of 0.1-5 mol-%. Extensive tests have demonstrated that even a small amount of nitrogen, such as 0.2-3.5 mol-% or further preferred even less than 1 mol-%, is effective to counteract the recognized process of mechanical failure and to obtain significantly improved service life of the lamp.

Nitrogen may easily be added to the gas filling, especially preferred as N₂. Thus, the object of providing a halogen lamp for pulse operation which has a significantly improved lifetime is achieved in an easy and inexpensive way.

Apart from the nitrogen addition in the filling, the lamp may correspond to known automotive lamp designs. Preferably, the filament is made of tungsten material doped with other elements in a concentration of less than 500 ppm. Especially preferred is tungsten material doped with 30-200 ppm potassium. Known materials of this type, which are referred to as “non-sag tungsten”, may comprise e.g. 60-100 ppm of potassium and minor additions of aluminum, silicon and oxygen.

The gas filling within the lamp vessel is preferably provided with a cold (22° C.) filling pressure of 0.5−2×10⁶ Pa, especially preferred of values of 1.3−1.7×10⁶ Pa. The rare gas component in the gas filling, which may be any of neon, argon, krypton or xenon or a mixture thereof, is preferably provided in more than 96 mol-%, further preferred more than 98 mol-%.

According to a preferred embodiment of the invention, the gas filling further comprises oxygen in an amount of 0.001-0.04 mol-%, preferably 0.005-0.002 mol-%. The addition of oxygen along with halogen serves to prevent blackening of the lamp vessel.

The halogen component may be provided in less than 0.5 mol-%. Generally, the halogen component may comprise one or more of iodine, bromine and chlorine. According to a preferred embodiment of the invention, the halogen component comprises chlorine and is preferably substantially free (except for impurities, i. e. containing less than 50 ppm, i. e. 5×10⁻³ mol-%) of bromine and iodine. It is preferred for the halogen component, which comprises or entirely consists of a chloride to be present in 0.01 to 0.05 mol-%. It has been found that using a halogen component consisting only of a chloride is particularly advantageous for preventing blackening of the lamp vessel.

Preferably, the lamp has electrical properties suited for the intended automotive use. Preferred is a rated power of 40-75 W at a rated voltage of 10-14 V. In order to fulfill the requirements for an automotive lamp suited for use in bending light and cornering light, it is preferred for the lamp to deliver, at its rated voltage, a luminance of more than 25 Mcd/m2. The given values for luminance may be achieved by a suitable filament design, especially with a filament design leading to filament temperatures above 2900° C. in steady state operation at the rated power/voltage. Possible lamp types include for example H1, H4, H7, H9 and H11.

For use of the lamp in a reflector of a headlight unit, it is preferred that the lamp vessel is fixed to a lamp socket, which will usually be made of plastic and/or metal material. The lamp socket comprises an electrical connector, electrically connected to the filament. Preferably, the electrical connector is a plug connector in accordance with automotive standard plug shapes. Further, the lamp socket comprises a locating flange, which serves for adjustment of the lamp within a reflector. The locating flange preferably extends transversely to the longitudinal direction of the lamp and may comprise reference elements for axial and/or radial alignment of the lamp within a reflector.

The lighting assembly according to the invention includes a driving unit for supplying electrical power and a lamp connected to this driving unit. The driving unit includes a pulse driving unit to supply pulsed electrical power. It should be noted that for the pulse driving unit it is only necessary that pulsed electrical power is supplied to the lamp at specified times, and that the lamp may be supplied with DC electrical power at other times. Preferably, the pulse driving unit is controllable so that the driving scheme, i.e. the timing parameters of the pulsed electrical power, are adjusted in response to a control input. Thus, operation may be achieved where the time average electrical power, calculated over a full cycle, varies over time. By such operation, the intensity of the lamp may be gradually decreased prior to turning the lamp off completely, e.g. by supplying the lamp with pulse-width modulated voltage with a gradually decreasing duty cycle.

Preferably, the pulse driving unit power supplies electrical power to the lamp with a peak voltage, which is preferably held constant during the “on”-phases, of 8-30 V at a switching frequency of 50-1000 Hz, further preferred 10-14 V at 100-500 Hz. The driving scheme is preferably chosen such that the lamp is supplied with an effective voltage corresponding to its nominal voltage (for constant operation) or below (for dimmed operation), including a continuously decreasing effective voltage (for soft turn-off).

For the lighting assembly, it is further preferred that the lamp is installed in a reflector of a motor vehicle headlight unit, to fulfill the desired function of bending light and cornering light. Preferably, the reflector may be shaped and arranged such that the center of the emitted light beam has an angle of 30-90° relative to the longitudinal axis of the motor vehicle.

These and other aspects of the invention will be apparent from and elucidated with reference to the embodiments described hereinafter.

### BRIEF DESCRIPTION OF THE DRAWINGS

These and other aspects of the invention will be apparent from and elucidated with reference to the embodiments described hereinafter.

In the drawings,

FIG. 1 shows a side view of a halogen automotive lamp for pulse operation according to the invention,

FIG. 2 shows, partly in cross-section, a headlight including the lamp of FIG. 1 installed in a reflector,

FIG. 3 shows a symbolical representation of a lighting assembly with a motor vehicle headlight unit and a driving unit,

FIG. 4 shows a symbolical representation of a timing diagram for operation of cornering/bending light.

### DETAILED DESCRIPTION OF EMBODIMENTS

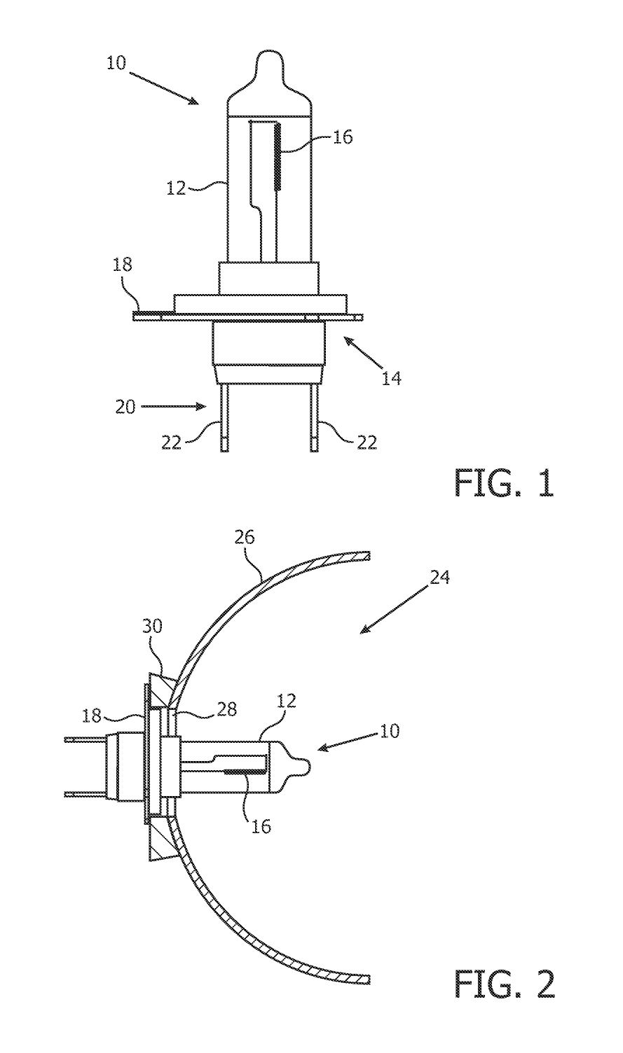

FIG. 1 shows an automotive lamp 10 comprising a glass lamp vessel 12 and a socket 14. Inside the lamp vessel 12, a filament 16 of doped tungsten material is arranged.

The socket 14 comprises a metal locating flange 18 and an electrical connector portion 20 with protruding plug contact 22, which are electrically connected to the filament 16.

The lamp 10 is intended for use in an automotive headlight 24 as shown in FIG. 2. The headlight 24 comprises a reflector 26 including a central mounting opening 28 with a mounting ring 30. The lamp 10 is installed in the headlight 24 by arranging it within mounting opening 28, such that the lamp vessel 12 with filament 16 is arranged within the reflector volume. Lamp socket 14 is thereby arranged at the mounting ring 30. Here, locating flange 18 is positioned on the mounting ring 30 to ensure exact axial positioning of the lamp 10 within the reflector 26.

The lamp 10 shown is an automotive halogen lamp. The specific shape shown in FIG. 1 is only an example of a possible shape of a lamp vessel 12, size and position of filament 16 as well as the shape of locating flange 18 and electrical connector 20. The lamp 10 may be, for example, a H1 lamp with a single axial filament as shown and a rated power of 55 W at 12 V. Alternatively, the lamp may be e.g. a H7 or H11 lamp (rated power of 55 W at 12 V). Further alternatively, the lamp may be of still different type, such as e.g. H9 (rated power of 65 W at 12 V).

For all of the above types, the lamp 10 has a high luminance, as required for an automotive headlight lamp. The filament coil 16 in operation achieves a temperature of more than 2900° C. The luminance at the rated power is above 25 Mcd/m2, e.g. 30 Mcd/m2 for the H7 lamp.

Lamp vessel 12 comprises a gas filling including a rare gas component and a halogen component. In the present example, the rare gas component is krypton at a cold filling pressure of 15×10⁶ Pa (15 bar).

In a first embodiment, the halogen component consists of a mixture of iodine, bromine and chloride.

Further, the gas filling comprises gaseous nitrogen (N₂) in an amount of 0.8 mol-%. As will be explained below, this minor addition of nitrogen serves to obtain a significantly improved lifetime of the lamp 10 if it is operated with a pulsed voltage.

As will also be further explained below, in some automotive applications, such as a turning-off sequence of bending light and cornering light, a halogen lamp may be operated with pulsed electrical power. In the present context, this is understood to designate a mode of operation where electrical power is applied in discrete pulses of essentially constant voltage to the lamp 10, and where these pulses are separated by intervals in which substantially no electrical power is supplied to the lamp. A well-known pulse driving scheme is pulse-width modulation (PWM), where at a constant pulse frequency (f), which in automotive applications may e.g. be chosen at 100 Hz, pulses of a predetermined duration are provided. The duty cycle is defined as the fraction of time that the pulse is active within the cycle. Thus, e.g. a duty cycle of 50% corresponds to a driving scheme where the “on” duration is equal to the duration of the “off” interval between pulses. A duty cycle of 100% corresponds to DC operation.

An analysis of failures of lamps operated with PWM has revealed a deformation of filaments. Studies conducted by the present inventor seem to indicate that a reason for filament deformation is thermal stress induced by the pulsed operation. However, stresses are not uniformly caused within the filament, but have been found to concentrate on certain filament inhomogeneities. In the course of operation with a large number of cycles, the stress is responsible for filament deformation, leading to premature lamp failure.

It has now be found that it is possible to lessen or even prevent this effect by a nitrogen addition to the gas filling serves to prevent deformation. As tests have demonstrated, even small amounts of nitrogen, such as less than 1 mol-% N₂ in the gas filling, have a substantial effect in preventing deformation, leading to significantly increased lifetime under pulse operating conditions, especially if driven in a pulse width modulation scheme.

In the following, use of the lamp 10 which as described above comprises nitrogen in the gas filling, is explained for bending light and cornering light.

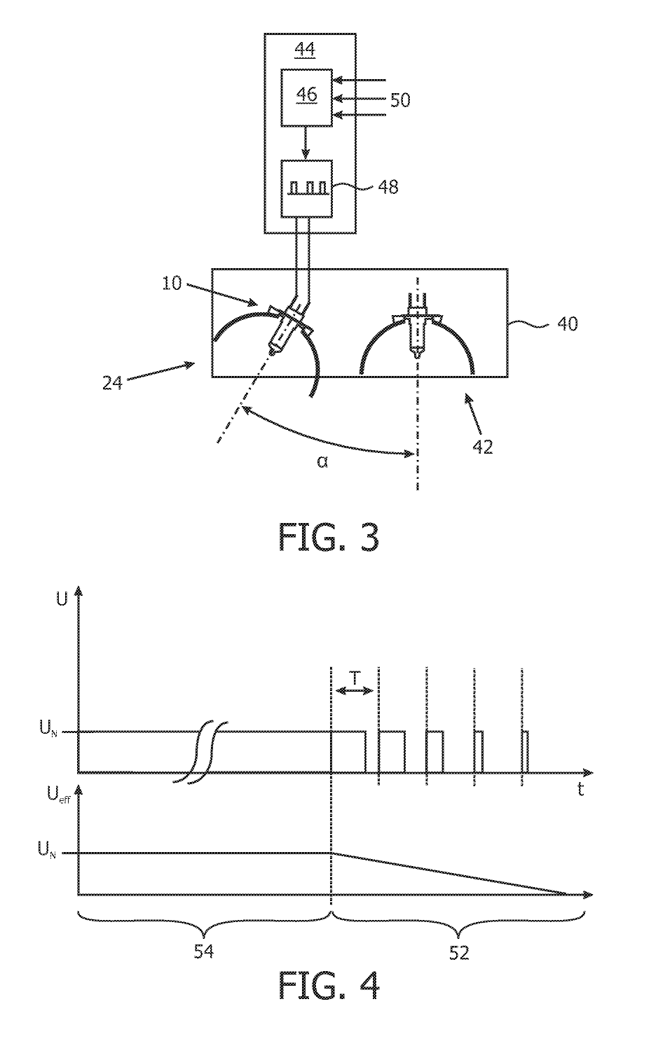

FIG. 3 shows in a symbolic representation an automotive lighting assembly comprising a headlight unit 40 with a front headlight 42 and a bending/cornering headlight 24 as described above in connection with FIG. 2. While the front headlight 42 is arranged on an optical axis parallel to the longitudinal direction of a motor vehicle, the bending/cornering headlight 24 is arranged under an angle a thereto, which may be e.g. 30-90°.

The lamp 10 within the bending/cornering headlight 24 is electrically connected to a driving unit 44. The driving unit 44 comprises a control unit 46 and a pulse driving unit 48. The control unit 46 controls the way, in which the pulse driving unit 48 supplies electrical power to the lamp 10.

The driving unit 44 receives input signals generally designated as 50 allowing automatic operation of the bending and cornering light functionalities. At a steering angle of above 10°, the bending light is activated. If the direction indicator is activated, the cornering light is also activated.

FIG. 4 shows in a symbolic representation the electrical driving scheme of the lamp 10 in its function as bending light or cornering light. If the input signals 50 indicate to the control unit 46 that bending/cornering light should be activated, pulse driving unit 48 is first controlled to supply constant electrical power to the lamp 10. This may be the full onboard DC voltage (which could be seen as 100% duty cycle) or, alternatively, a PWM modulated voltage with a constant effective voltage value. For example, an onboard voltage of 14 V DC may be modulated to achieve an effective voltage Veff of 12 V. Consequently, the lamp 10 is operated in an interval 50 with a constant effective voltage UN corresponding to the rated voltage of 12 V of the lamp 10.

If the input signals 50 indicate to the control unit 46 that bending/cornering light should be turned off, a turn-off sequence is initiated in a time interval 52. Within the time interval 52, the lamp 10 is driven with a pulse-width modulated voltage at a constant peak voltage UN corresponding to the rated voltage of the lamp 10, a fixed switching frequency of 100 Hz and a continuously decreasing duty cycle. Thus, as illustrated in FIG. 4 (although, in practice the interval 52 will comprise a significantly larger number of switching cycles T) the effective voltage Ueff and therewith average electrical power delivered to the lamp gradually decreases, such that the intensity of the emitted light decreases also. In this way, bending/cornering light is not switched off instantly, but is gradually reduced to zero in order not to cause irritation.

In a second embodiment, the lamp vessel 12 comprises a gas filling, where the rare gas component is again krypton at a cold filling pressure of 1.5×10⁶ Pa (15 bar). The gas filling comprises gaseous nitrogen (N₂) in an amount of 0.8 mol-%, which has proven effective against filament deformation. Further, the gas filling comprises gaseous oxygen (O₂) in an amount of 0.001 mol-% up to 0.003 mol-%.

The gas filling further comprises a halogen component. In this preferred example, the halogen component consists only of a chloride, specifically 0.015-0.03 mol-% CH₂Cl₂.

It has been found that the addition of oxygen is advantageous for a working halogen cycle and the use of a halogen component that is essentially free both of bromine and iodine serves to prevent blackening of the lamp.

It should be understood that the invention is not limited to the disclosed embodiments. The invention may advantageously be used for any automotive halogen lamp subjected to pulse operation and is not limited to the mentioned standardized types of lamps or the special driving scheme discussed above. Further, the invention is not limited to specific compositions of a halogen component and a rare gas component within the gas filling.

Tests with different halogen compositions and with different amounts of N₂ of 0.8 mol-%, 1.0 mol-%, 2.0 mol-% and 3.5 mol-% have been conducted. The described effect was observed in all cases, where the lamps were subjected to a PWM test cycle to measure lifetime.

It has thus been found that the proposed addition of nitrogen serves its purpose of preventing filament deformation with different halogen and rare gas compositions.

Further, the terms “comprising” and “including” do not exclude other elements or steps, the use of “a” or “an” does not exclude a plurality. A unit, e.g. the driving unit, control unit and operating unit discussed with regard to FIG. 3, may fulfill the function of several means recited in the claims.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

### LIST OF REFERENCE SIGNS

10 lamp
12 lamp vessel
14 lamp socket
16 filament
18 flange
20 electrical connector
22 contact
24 headlight
26 reflector
28 mounting opening
30 mounting ring
40 headlight unit
42 front headlight
44 driving unit
46 control unit
48 pulse driving unit
50 input signals
52 pulse time interval
54 steady operation time interval

1. Halogen automotive lamp for pulse operation, comprising
a transparent lamp vessel (12) with a gas filling comprising a rare gas component and a halogen component,
and a filament (16) arranged within said vessel,
said gas filling further comprising nitrogen in an amount of 0.1-5 mol-%.

2. Lamp according to claim 1, where
said gas filling comprises nitrogen in an amount of less than 1 mol-%.

3. Lamp according to one of the above claims, where
said filament is made of a tungsten material doped with less than 500 ppm of other elements.

4. Lamp according to claim 3, where
said tungsten material is doped with 30-200 ppm potassium.

5. Lamp according to one of the above claims, where
said filling is provided with a cold filling pressure of 0.5−2×10⁶ Pa,
where said filling comprises said rare gas component in more than 96 mol-%.

6. Lamp according to one of the above claims, where
said gas filling further comprises oxygen in an amount of 0.001-0.03 mol-%.

7. Lamp according to one of the above claims, where
said halogen component comprises chlorine and is substantially free of bromide and iodine.

8. Lamp according to one of the above claims, where
said lamp vessel (12) is fixed to a lamp socket (14), said lamp socket (14) comprising a locating flange (18) for alignment of the lamp (10) within a reflector (26),
where said lamp socket (14) comprises an electrical connector (20) which is electrically connected to said filament (16).

9. Lamp according to one of the above claims, said lamp having a rated voltage of 10-14 V and a rated power of 40-75 W.

10. Lamp according to one of the above claims, said lamp having a luminance of more than 25 Mcd/m2.

11. Lighting assembly including
a halogen lamp (10) comprising a transparent vessel (12) with a gas filling comprising a rare gas component and a halogen component, and a filament (16) arranged within said vessel (12),
where said gas filling further comprises nitrogen in an amount of 0.1-5 mol-%,
and a driving unit (44) to supply electrical power to said lamp (10),
where said driving unit (44) includes a pulse driving unit (48) to supply pulsed electrical power to said lamp (10).

12. Assembly according to claim 11, where
said pulsed driving unit (48) is adapted to supply electrical power to said lamp with a peak voltage of 8-30 V at a switching frequency of 50-1000 Hz.

13. Assembly according to one of claims 11, 12, where
said pulsed driving unit (48) is disposed to supply electrical power to said lamp (10) such that the average power varies over time.

14. Assembly according to one of claims 11-13, where
said lamp is installed in a reflector (26) of a motor vehicle headlight unit (40).

15. Method of operating a halogen lamp, where
said lamp (10) comprises a transparent lamp vessel (12) with a gas filling comprising a rare gas component and a halogen component, and a filament (16) arranged within said vessel (12),
and where said gas filling further comprises nitrogen in an amount of 0.1-5 mol-%,
where said lamp is operated with pulsed electrical power.
